(19) United States
(12) Patent Application Publication
(10) Pub. No.: US 2007/0144056 A1
(43) Pub. Date: Jun. 28, 2007

(54) Insect Erradication Apparatus

(76) Inventor: Frank H. Gleason JR., Anaheim, CA (US)

Correspondence Address: QUICKPATENTS, INC., 32861 CALLE PERFECTO, SUITE A, SAN JUAN CAPISTRANO, CA, 92675, US

(21) Appl. No.: 11/614,781

(22) Filed: Dec. 21, 2006

Related U.S. Application Data
(60) Provisional application No. 60/597,960, filed on Dec. 28, 2005.

(51) Int. Cl. A01M 1/22

(52) U.S. Cl. 43/112; 43/107

(57) ABSTRACT

An apparatus for exterminating undesirable insects is disclosed. The apparatus includes a generally hollow enclosure that has a top portion and a bottom portion. The top portion includes at least one insect entrance comprising an inward-oriented frusta-conical member that includes an aperture at a top portion thereof. Undesirable insects that enter an entrance become trapped within the enclosure. A plurality of electrically conductive wire mesh grids are held inside the top portion generally parallel to each other. An electronic circuit is included for producing a high-voltage charge across each adjacent grid, such that when an insect flies or crawls between two such adjacent grids, an electrical current arcs from one grid, through the insect, to the other grid, thereby killing the insect. The circuit is preferably battery powered, such batteries being rechargeable by a solar panel, and includes a plurality of light sources and photoelectric detectors arranged such that a light beam traversed just on the inside of each aperture of each entrance. As such, when an insect enters the enclosure, the electronic circuit is activated to produce the high-voltage charge across each adjacent grid for a preset duration of time. An internal insect attractant means, such as a plastic tray for holding insect attracting bait, is included in the bottom portion.

### CROSS-REFERENCE TO RELATED APPLICATIONS

This application claims the benefit of U.S. Provisional Patent Application 60/597,960, filed on Dec. 28, 2005.

### STATEMENT REGARDING FEDERALLY SPONSORED RESEARCH AND DEVELOPMENT

Not Applicable.

### FIELD OF THE INVENTION

This invention relates to insect destroying devices, and more particularly to an enclosed insect electrocution devices.

### DISCUSSION OF RELATED ART

Insect electrocution devices are known in the art, typically employing an ultraviolet light to lure insects into a high-voltage grid. However, such devices are not effective for a wide variety of flying insects, nor do they provide effective means for containing dead insects therein. Typical of such devices is that insects fall through an open bottom mesh that results in a pile of dead insects on the ground directly below such devices. Further, certain desirable flying insects are just as likely to be exterminated with the prior art devices, as such devices do not have means for discriminating between desirable and undesirable insects. Still further, such devices are typically line powered and always on, resulting in energy waste and inefficient operation. Moreover, such devices must be installed close to a wall outlet or other line power source, limiting the installation options and effective areas of use.

Therefore, there is a need for a battery-operator solar-rechargeable insect electrocuting device that is effective for a wide variety of undesirable flying insects, yet does not allow desirable insects to be exterminated. Such a needed device would be a safe, sanitary, energy efficient, low-cost and durable apparatus that is installable virtually anywhere, even in sanitarily-sensitive areas such as kitchens, or the like. The present invention accomplishes these objectives.

### SUMMARY OF THE INVENTION

The present invention is an apparatus for exterminating undesirable insects and leaving desirable insects such as butterflies and moths safe. The apparatus includes a generally hollow enclosure that has a top portion and a bottom portion that are mated together in a sealed relationship to form the enclosure. The top portion includes at least one undesirable insect entrance, each comprising an inward-oriented frusta-conical member that includes an aperture at a top portion thereof. Undesirable insects that enter an entrance become trapped.

A plurality of electrically conductive wire mesh grids are further included and held inside the top portion generally parallel. Each grid includes a plurality of apertures suitable for allowing the insects therethrough. An electronic circuit is included for producing a high-voltage charge across each adjacent grid, such that when an insect flies or crawls between two such adjacent grids, an electrical current arcs from one grid, through the insect, to the other grid, thereby killing the insect. The circuit is preferably battery powered, such batteries being rechargeable by a solar panel.

The electronic circuit preferably further includes a plurality of light sources and photoelectric detectors arranged such that a light beam traversed just on the inside of each aperture of each entrance. As such, when an insect enters the enclosure, the electronic circuit is activated to produce the high-voltage charge across each adjacent grid for a preset duration of time, such as two minutes. A trapped insect has a high probability of traversing between the grids while the grids are charged, yet the device is activated only intermittently as needed in order to preserve battery life.

Further, an insect attractant means, such as a plastic tray, is included in the bottom portion of the enclosure. The enclosure preferably includes a hanger of both a top surface thereof and a bottom surface thereof. As such, the enclosure may be suspended with the top portion oriented upward to attract flies and other undesirable insects, or with the bottom portion oriented upward with a bait suspended from a bait hook for attracting hornets, wasps, yellow jackets, and the like. The insect attractant means may further include an insect attracting light and, optionally, a carbon dioxide generator to further attract flies, mosquitoes, and the like.

The present invention is a battery-operator solar-rechargeable insect electrocuting device that is effective for a wide variety of undesirable flying insects, yet does not allow desirable insects to be exterminated. Such a needed device is a safe, sanitary, energy efficient, low-cost and durable apparatus that is installable virtually anywhere, even in sanitarily-sensitive areas such as kitchens, or the like. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention;

FIG. 2 is a cross-sectional view of the invention, taken generally along lines 2-2 of FIG. 1;

FIG. 3 is a cross-sectional view of the invention, taken generally along lines 3-3 of FIG. 1;

FIG. 4 is a cross-sectional view of the invention, taken generally along lines 4-4 of FIG. 2; and

FIG. 5 is a partial elevational view of the invention, taken generally along lines 5-5 of FIG. 4.

### DETAILED DESCRIPTION OF THE PREFERRED EMBODIMENT

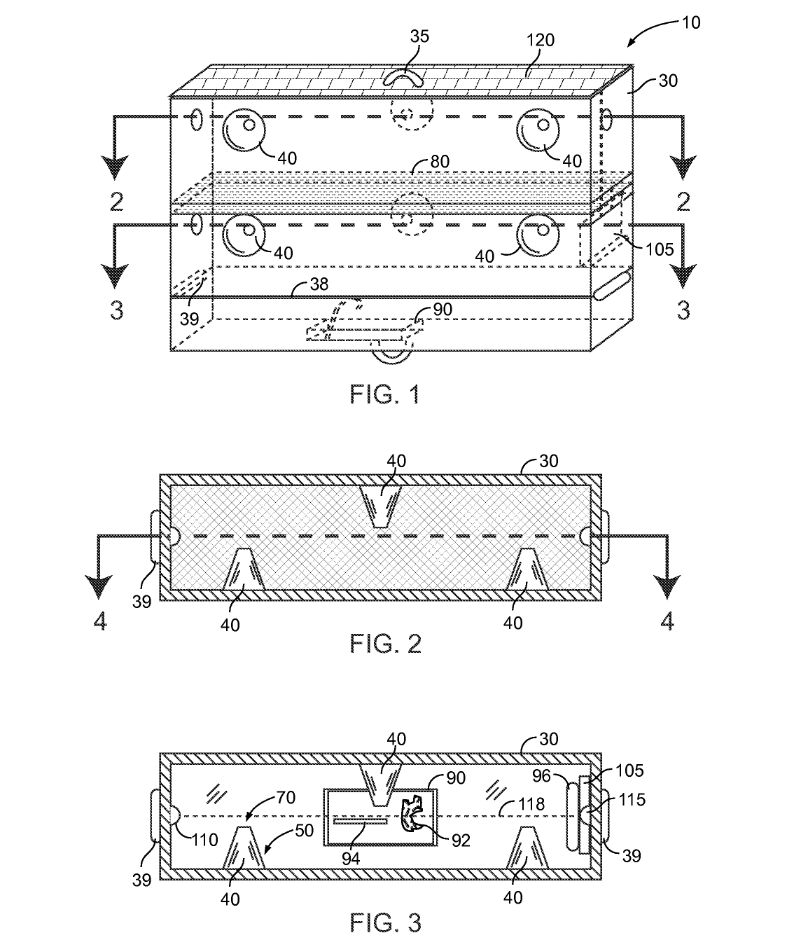

FIGS. 1, 4 and 5 illustrate an apparatus 10 for exterminating undesirable insects 20. The apparatus 10 includes a generally hollow enclosure 30 that has a top portion 32 and a bottom portion 34. Each portion 32,34 include a mating seal 38 having cooperating sealing means 39 (FIGS. 1 through 4) that allows the top and bottom portions 32,34 to be selectively mated together in a sealed relationship to form the enclosure 30. Such sealing means 39 may include plastic snap-type latches or the like, as is commonly known in the art. Each portion 32,34 is preferably made from a rigid translucent or transparent plastic material, such as polyethylene, polyvinyl chloride, acrylic, or the like. In one alternate embodiment of the invention, however, the enclosure is made from an opaque material.

The top portion 32 includes at least one undesirable insect entrance 40, each comprising an inward-oriented frusta-conical member 50 that includes an aperture 60 at a top portion 70 thereof (FIGS. 2 and 3). Undesirable insects 20 may enter an entrance 40, but due to the shape of the entrance, once inside the enclosure 30, such insects become trapped and cannot find the small aperture 60 through which to escape. Desirable insects, such as moths and butterflies, for example, are unable to enter the apparatus 10. Such entrances 40 may be attached to the enclosure 30 through conventional means, such as a bonding agent or mechanical snap means (not shown), or formed integrally with the top portion 32.

A plurality of electrically conductive wire mesh grids 80 are further included and held inside the top portion 32 generally parallel to each other and generally a distance d apart (FIG. 5). Preferably two grids 80 are included, and the distance d is about 1/16 of an inch. The grids 80 may be held apart from each other by grid mounting means 85 formed integrally in the top portion 32, or, alternately, with insulating spacers (not shown) or other means common in the art. Ideally, however, each grid 80 is durable and rigid enough to remain substantially flat so that the distance d between each grid 80 is maintained across the entire area of the grids 80. Further, each grid 80 includes a plurality of apertures suitable for allowing the insects 20 therethrough.

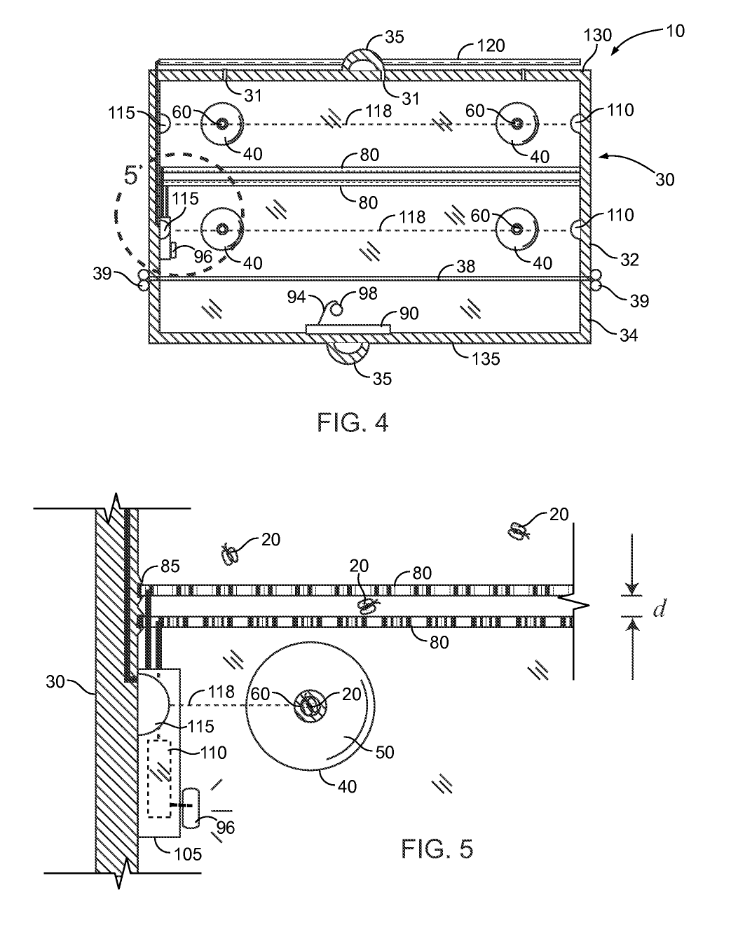

An electronic circuit 100 is included for producing a high-voltage charge across each adjacent grid 80, such that when an insect flies or crawls between two such adjacent grids 80, the electric resistance between the grids is reduced sufficiently to allow an electrical current to arc from one grid 80, through the insect 20, and to the other grid 80, thereby killing the insect 20. The circuit 100 is preferably battery powered, such batteries (not shown) being rechargeable by a solar panel 120 (FIGS. 1 and 4). The solar panel 120 is preferably detachable from the enclosure 30 with conventional means, such that the solar panel 120 may be optimally positioned to capture sunlight during the day.

The electronic circuit 100 preferably further includes a plurality of light sources 115, such as laser diodes, LEDs, or the like, and photoelectric detectors 110 arranged such that a light beam 118 traversed just on the inside of each aperture 60 of each entrance 40. As such, when an insect 20 enters the enclosure 30, the electronic circuit 100 is activated to produce the high-voltage charge across each adjacent grid 80 for a duration of time, such as two minutes. A trapped insect 20 has a high probability of traversing between the grids 80 while the grids 80 are charged, yet the device is activated only intermittently as needed in order to preserve battery life. FIG. 4 illustrates the enclosure 30 having a plurality of entrances on both sides of the grids 80. In such an embodiment, the light sources 115 may be visible to insects 80, thereby luring insects 20 to cross through the grids 80.

Preferably the electronic circuit 100 includes a voltage inverter for producing the high-voltage charge across the grids 80, and further includes means for powering the light sources 115 and the photoelectric detectors 110. Further, the electronic circuit 100 is preferably in a circuit enclosure 105 to protect the circuit 100 from the elements and debris. The circuit 100 may include a mode switch (not shown) for selectively deactivating the high-voltage grids, whereby trapped insects are merely trapped and contained until they die through thirst, starvation, or the like.

In an alternate embodiment of the invention, however, the electronic circuit 100 is A/C line powered, such as from a 110V AC outlet. In such an embodiment, an electrical power cord is included (not shown), and an electrical inverter is replaced with a step-up transformer.

The enclosure 30 preferably includes a hanger 35 of both a top surface 130 thereof and a bottom surface 135 thereof (FIGS. 1 and 4). Further, an insect attractant means 90, such as a plastic tray, includes a bait hook 94 for suspending an insect bait 98 away from any surfaces, such that certain undesirable insects 20 such as hornets, wasps and yellow jackets are attracted thereto. Other insect bait 92, such as cat feces or the like, may be placed inside the tray 90. Consequently, the enclosure 30 may be suspended with the top portion 32 oriented upward to attract flies and other undesirable insects, or the enclosure may be suspended with the bottom portion 34 oriented upward with a bait 98 suspended from the bait hook 94 for attracting hornets, wasps, yellow jackets, and the like.

The insect attractant means 90 may further include an insect attracting light 96 and, optionally, a carbon dioxide generator (not shown) to further attract flies, mosquitoes, and the like. In such an embodiment, the electronic circuit 100 includes means for powering the light 96 and the carbon dioxide generator. Once a lower photoelectric detector 110 is tripped, indicating that an insect 20 has entered the lower portion 34 of the enclosure 30, the electronic circuit 100 may shut down the insect attracting light 96 in the lower enclosure 34 in order to allow the insect 20 to be attracted by the internal light source 115, increasing the probability that the insect 20 will traverse the grids 80.

Various configurations of entrances 40 and enclosures 30 may cooperate in this manner with the electronic circuit 100 to increase the efficiency of the apparatus 10 while maximizing battery life, particularly at night when the solar cells 120 are not able to recharge the batteries.

Air vents 31 are included in the top surface 130 of the enclosure 30 for allowing the carbon dioxide or other insect attracting odors to escape the enclosure 30 in order to attract the undesirable insects 20 to the apparatus 10.

While a particular form of the invention has been illustrated and described, it will be apparent that various modifications can be made without departing from the spirit and scope of the invention. For example, FIGS. 1 through 4 illustrate an enclosure 30 that is generally box-like, but may alternately be a sphere or another shape altogether. Further, the exact placement and number of the insect entrances 40 may be altered as well. Accordingly, it is not intended that the invention be limited, except as by the appended claims.

What is claimed is:

1. An apparatus for exterminating undesirable insects, comprising:
a generally hollow enclosure, the enclosure including at least one undesirable insect entrance that includes an inward-oriented frusta-conical member having an aperture at a top portion thereof,
a plurality of electrically conductive wire mesh grids held generally parallel to each other substantially a distance d apart, each grid effectively sealing a top portion of the enclosure off from a bottom portion, each grid allowing the undesirable insects to pass therethrough;
an insect attractant means; and
an electronic circuit for producing a high-voltage charge across each adjacent grid;
whereby undesirable insects are attracted to the insect attractant means, enter the enclosure through one of the undesirable insect entrances, cross between the pair of grids, thereby lowering the electrical resistance enough between the grids to cause an electric arc to travel between the grids through the insect, thereby killing the insect.

2. The apparatus of claim 1 wherein the top portion and the bottom portion of the enclosure are separated, each portion including a mating seal having cooperating sealing means for selectively mating each portion together to form the enclosure.

3. The apparatus of claim 1 wherein the plurality of electrically conductive wire mesh grids includes exactly two wire mesh grids, each separated by a distance of about 1/16 of an inch.

4. The apparatus of claim 1 wherein the electronic circuit further includes at least one battery for powering the circuit, and further including a solar panel electrically connected with the electronic circuit and fixed to the outside of the enclosure for recharging the at least one battery.

5. The apparatus of claim 4 wherein the solar panel may be selectively detached from the enclosure, whereby the solar panel may be optimally positioned to receive sunlight.

6. The apparatus of claim 1 further including at least one light source and at least one photoelectric detector, each arranged such that the light source produces a light beam across the aperture of at least one of the entrances, the light source and photoelectric detector electrically interconnected to the electronic circuit, whereby the electronic circuit may conserve power by charging each wire mesh grid only after an insect has been detected by the photoelectric detector.

7. The apparatus of claim 6 wherein at least one of the light sources is attractive to the undesirable insects, and wherein the enclosure is non-opaque.

8. The apparatus of claim 1 further including a mode switch for selectively activating or deactivating the charging of the high-voltage wire mesh grids.

9. The apparatus of claim 1 wherein the electronic circuit further includes an electrical power cord interconnected with the electronic circuit, and wherein the electronic circuit further includes a step-up transformer.

10. The apparatus of claim 1 wherein the insect attractant means is a bait hook for suspending an insect bait thereby.

11. The apparatus of claim 1 wherein the insect attractant means is a removable tray for containing the insect bait therein.

12. The apparatus of claim 1 wherein the insect attractant means is a carbon dioxide generator electrically interconnected with the electronic circuit.

13. The apparatus of claim 12 wherein the enclosure further includes a plurality of air vents in a top surface thereof.

14. The apparatus of claim 10 wherein the insect attractant means further includes a removable tray for containing the insect bait therein.

15. The apparatus of claim 14 wherein the enclosure includes a hanger on both a top surface thereof and a bottom surface thereof, whereby the apparatus may be suspended by either the top surface hanger or the bottom surface hanger.
